(19) United States
(12) Patent Application Publication
(10) Pub. No.: US 2011/0204530 A1
(43) Pub. Date: Aug. 25, 2011

(54) Single barrel carburetor

(76) Inventor: Patrick James, Weeki Wachee, FL (US)

(21) Appl. No.: 12/708,680

(22) Filed: Feb. 19, 2010

(51) Int. Cl. F02M 17/20; F02M 19/02

(52) U.S. Cl. 261/64.1; 261/119.2

(57) ABSTRACT

The single body passage (single barrel) carburetor main body design for air demand. The carburetor main body design includes a single throttle plate, a main body assembly, boosters associated with a main fuel delivery circuit, idle fuel delivery passages, transfer circuit delivery passages, air venting passages, bowl venting passages and accelerator pump passages. The idle circuit ports open downstream of the throttle plate. Transfer circuit discharge ports are positioned across the throttle plate. The combination of the idle, transfer and main fuel circuits ensures the smooth delivery of fuel throughout all operating conditions of the engine. The modular metering design incorporated with the multiple outlet booster design allows improved control of the delivery of fuel in the single body passage (single barrel) and increased air flow capability.

### FIELD OF THE INVENTION

This invention relates generally to the field of carburetors for internal combustion engines. More specifically, this invention relates to a single barrel down draft carburetor for air demand engines.

### BACKGROUND OF THE INVENTION

High air demand engines, like most internal combustion engines, require a proper mixture of fuel and air to be fed into the combustion chamber of the cylinders. A common device for regulating the air/fuel mixture and delivering it to the combustion chamber is a carburetor. The carburetor controls engine fuel and air input and therefore greatly influences power output. The carburetor mixes fuel and air in the correct proportions for engine operation and atomizes and vaporizes the fuel/air mixture to facilitate combustion. While fuel injection has replaced carburetors in many of today's vehicles, carburetors continue to be used in high performance vehicles (i.e., race cars) particularly where space, cost, or performance preferences dictate.

Carburetors often have the same basic structure: a fuel inlet and reservoir (the fuel bowl assembly), which takes in and holds fuel for metering in the proper proportions; a main body, including a throttle valve and air passage, which admits air in one end and discharges the fuel/air mixture from the other; and one or more fluid circuits connecting the fuel bowl assembly to the main body. The actual design and orientation of the structures varies widely depending on the size, configuration, and performance needs of the engine.

High powered engines may employ many types of carburetor designs. The most popular example is the four barrel carburetor registered under U.S. Pat. No. 2,892,622 Inventor: C. R. Goodyear, Assignee: Holley Carburetor Company. A similar design for this patent application is shown in U.S. Pat. No. 4,670,195 issued to Robson; Richard E. G. (referred to herein as the Robson design). The mission of the Robson design appears to be that it was to simply improve atomization to even up the air to fuel ratios. But different engine cylinders require different ratios for proper operation. The Robson design does not serve the engines particular requirements nor does the design lend itself to achieve large air flow rates of current engine needs while utilizing currently available intake manifold mounting surfaces.

Engine power outputs have increased and available area on the carburetor mounting surface of most current intake manifold designs has not increased. Carburetors on performance engines disclosed in the aforementioned U.S. Pat. No. 2,892,622, have conventionally been of the four barrel type. This four barrel arrangement was to allow for better utilization of the available intake manifold shape to maximize available area for increased air flow. These four barrel carburetors were designed to supply the appropriate amount of air and fuel to each quadrant of the engine. This is often a difficult task even with four barrel design carburetors. However, large single passage carburetors showed less eddy resistance (increased flow versus area) but these single passage (single barrel) designs could not be built to flow sufficient air volume and still allow for proper control of the air to fuel delivery process for correcting the distribution of fuel into the intake manifold and the engines cylinders. This correction ability is required on almost any performance engine. The intake manifold for the engines different cylinders are usually of different lengths and the fuel is not typically distributed evenly and this created a problem for single barrel carburetors. One solution proposed by U.S. Pat. No. 4,204,585 to Tsuboi et al., incorporated herein by reference, proposes using a carburetor for each cylinder of the engine in the case of a multi-cylinder engine. But this increases the complexity of the package, as well as requires accommodation in the engine envelope, which may already be cramped. In sum, carburetors for high performance engines present specific design considerations not yet adequately met by current designs.

### SUMMARY OF THE INVENTION

A carburetor main body assembly for an engine may include a main body having a single body passage having a single intake port connected to a single discharge port, the discharge port for connecting to a plenum of the engine and a single throttle plate disposed within the single body passage, the throttle plate operable to regulate airflow through the body passage.

The main body may include a first section to supply fuel to the engine and a second section to supply fuel to the engine and then the first section may be independent in operation from the second section.

The first section may be a first quadrant, and the second section may be a second quadrant.

The carburetor main body may include a third section which is independent in operation from the first section and the second section, and the main body may include a fourth section which is independent in operation from the first section, the second section, and the third section.

The third section may be a third quadrant, and the fourth section may be a fourth quadrant.

The first section may include a first idle circuit, and the second section may include a second idle circuit.

The first idle circuit may operate independently of the second idle circuit and the first section may include a first transfer circuit.

The second section may include a second transfer circuit, and the first transfer circuit may operate independently of the second transfer circuit.

The first section may include a first main circuit, and the second section may include a second main circuit.

The first main circuit may operate independently of the second main circuit, and the carburetor assembly may include a first metering body which corresponds to the first section.

The carburetor assembly may include a second metering body which corresponds to the second section, and the first metering body may operate independently of the second metering body.

### BRIEF DESCRIPTION OF THE DRAWINGS

The invention may be understood by reference to the following description taken in conjunction with the accompanying drawings, in which, like reference numerals identify like elements, and in which:

FIG. 1 is a side/top view illustration of the carburetor body embodying the disclosed invention and denoting the booster, squirter, idle, vent, power valve and transfer fuel and air bleed passages.

FIG. 2 is a lower bottom view of the boosters displaced from their installed positions. It shows the booster atomization holes, the booster locating pins, the machined flat surface on the boosters, a bottom view of the single barrel (discharge port) and the idle and transfer slot passages.

FIG. 3 is a upper side view illustration of the accelerator pump system as utilized on the preferred embodiment;

FIG. 4 illustrates the internal passages of the present invention.

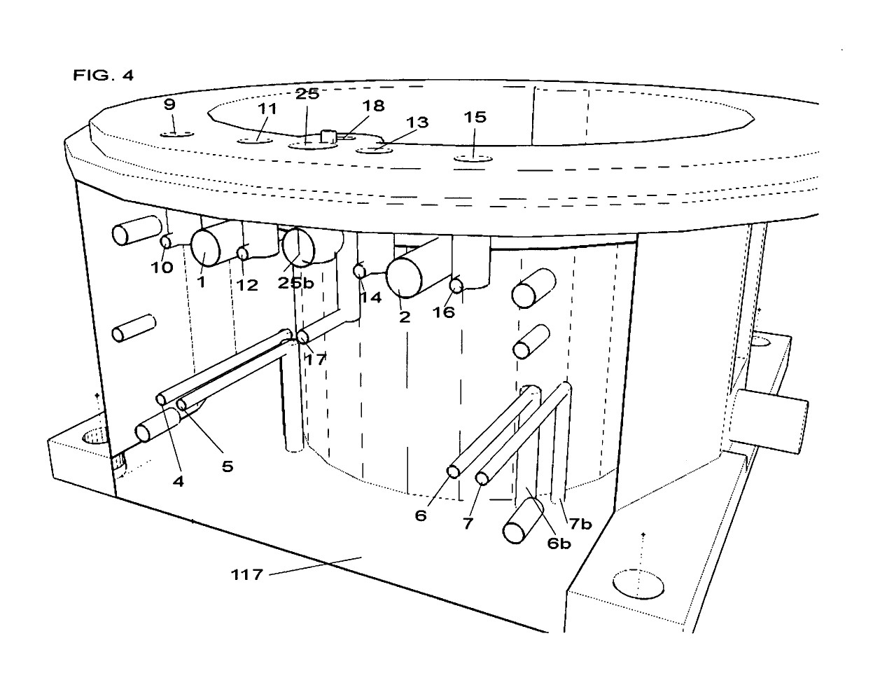

### DETAILED DESCRIPTION OF PREFERRED EMBODIMENTS

It is an object of the preferred embodiments to provide a single barrel carburetor for use in air demand engines.

It is further an object of the preferred embodiments to provide a number of external adjustments and interchangeable parts to allow detailed calibration and customization of a carburetor for a particular user's performance needs. These adjustments and interchangeable parts allow the engine to be more evenly tuned than current single barrel designs.

It is further an object of the preferred embodiments to create a design with reduced internal air flow (eddy resistance) as compared to prior art designs to provide increased air flow capabilities.

It is further an object of the preferred embodiments to utilize available intake manifold carburetor mounting surfaces in its incorporation to provide increased air flow capabilities.

It is further an object of the preferred embodiments to provide a discharge booster venturi that communicates with each quadrant of the carburetor.

It is further an object of the preferred embodiments to incorporate an improved method for calibrating the carburetor through a modular design with interchangeable parts.

It is further an object of the preferred embodiments to provide an improved engine carburetor which provides more horsepower.

It is further an object of the preferred embodiments to create a design with a dual bolt pattern configuration to allow it to be fitted to multiple intake manifold designs.

It is yet a further object of the preferred embodiments to provide a carburetor having “tunable” circuits, i.e., idle circuit, transfer circuit and main circuit, for each quadrant of the carburetors single body passage implemented by having interchangeable metering restrictions to allow the fuel delivery rate to be calibrated independently in each quadrant.

A single barrel (single passage) carburetor for high air demand engines is tunable in each quadrant by virtue of dedicated fuel metering devices, which may be tuned to optimize the performance of the engine. The preferred embodiment has also better utilized the available carburetor mounting surface for increased air flow to better suit engine demand over current multiple barrel carburetor designs. Likewise, a multiple barrel carburetor that allows independent calibration. The single barrel quadrant tunable design offers improved performance.

The invention of the preferred embodiments is also directed to a method of manufacturing and calibrating single barrel carburetors. The preferred method includes a modular design and interchangeable parts.

The carburetor may be either original equipment sold with the engine or an after-market performance add-on to replace an existing carburetor on an engine. In any event, dynamometer testing has revealed that the carburetor of the preferred embodiments delivers more horsepower.

These and other objects of the preferred embodiments are particularly achieved by a single barrel assembly for a engine. The carburetor has a main body forming a body passage. This cylindrical shaped body passage is described as being equipped with an intake port, a discharge port, and a main venturi or constriction. A butterfly throttle valve is disposed within the body passage between the constriction and the discharge port. The butterfly valve can be operated to regulate airflow through the body passage.

A fuel bowl assembly comprising a fuel intake valve and a fuel bowl body is required in the modular design of the system. The fuel bowl body forms a reservoir for fuel. At least one fluid channel connects the reservoir in the fuel bowl to the body passages. Fuel enters the carburetor assembly through the fuel intake valve and accumulates in the reservoir. Fuel is aspirated as it passes through the metering block(s) and the air/fuel mixture exits the discharge end of the booster(s). This is where it is combined with air entering the intake of the body passage and this combination of fuel and air exits the discharge port into the engine.

In its most basic form, the carburetor assembly for a engine comprising: A main body forming a body passage having an intake port, a discharge port, and a constriction; a throttle valve disposed within said body passage between the constriction and the discharge port of the said body passage, said throttle valve operable to regulate airflow through said body passage; a fuel bowl assembly or assemblies comprising fuel intake valve (s) and a fuel bowl(s) forming a reservoir(s); at least one fluid channel connecting said reservoir(s) to said body passage(s), fuel is aspirated within at least one fluid channel, and aspirated fuel is combined with air entering the constricted venturi section or intake end of the body passage. Finally, the air fuel mixture exits the discharge end of the body passage.

Other objects, features and advantages of the preferred embodiments will become apparent to those skilled in the art when the detailed description of the preferred embodiments is read in conjunction with the drawings appended here. This system can function with a single bowl assembly, a single fuel metering body (metering block) assembly and a booster (if the booster is fitted without the divider option). However the carburetor may utilize two fuel bowl and two metering assemblies and a divider in the booster assembly for even more fuel flow control over the engines demands.

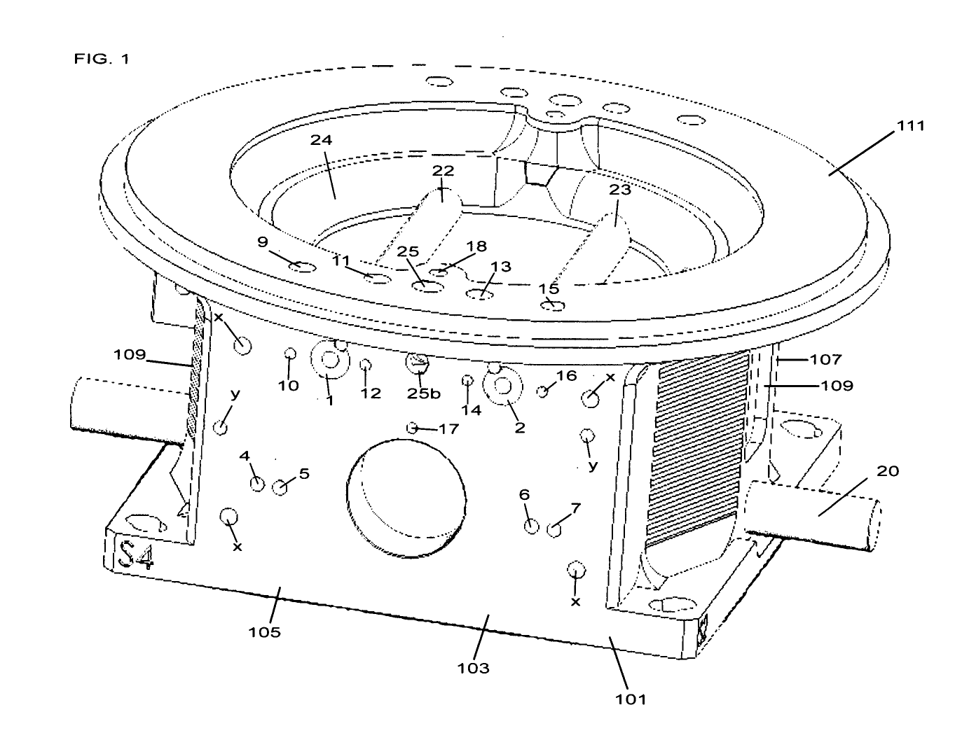

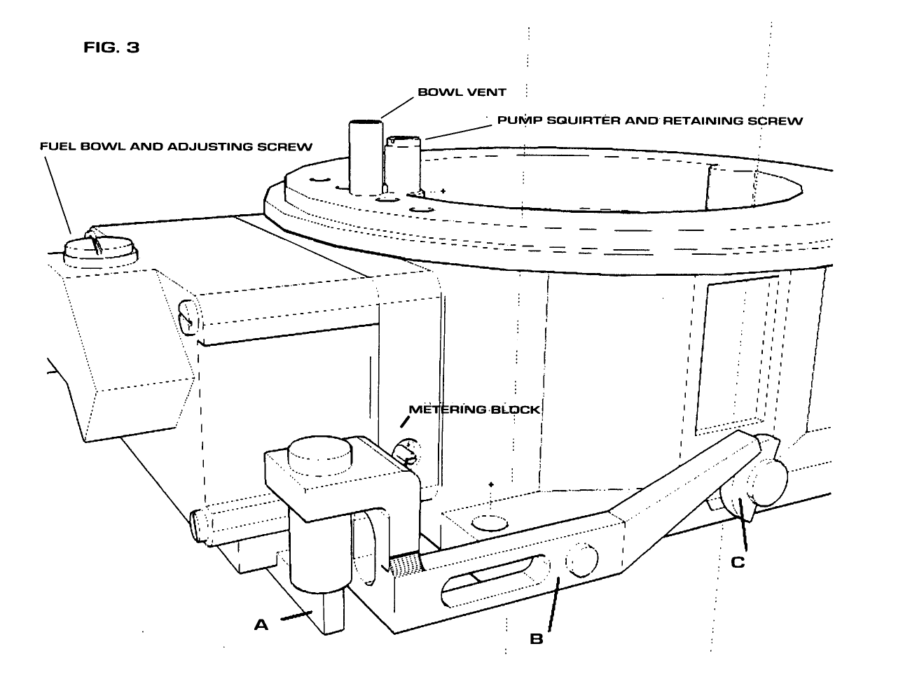

With reference to the drawing figures generally, and particularly to FIG. 1 which may illustrate a carburetor 100 which may include the single barrel main body assembly 24 for use in powered engines and may include a base member 101 to mount the main body assembly 24 and a housing member 103 which may include a front surface 105 which may be connected to opposing side surfaces 109 which may be connected to a back surface 107 which may be opposed to the front surface 105. A top surface 111 may be connected to the front surface 105, the opposing side surfaces 109 and the back surface 107 and may extend radially from the front surface 105, the opposing side surfaces 109 and the back surface 107. The carburetor 100 may include a single main body 24, a single throttle shaft 20, a single throttle blade 21, a first booster 22 and second booster 23. The carburetor 100 may include a fuel bowl sub assembly 113 (shown in FIG. 3) and described in for example U.S. Pat. No. 4,034,026 incorporated by reference in its entirety or any other appropriate fuel bowl sub assembly and may include a fuel metering body 115 which may be described for example in U.S. Pat. No. 5,591,383 incorporated by reference in its entirety or other appropriate fuel metering body. Other designs may be employed with the carburetor 100.

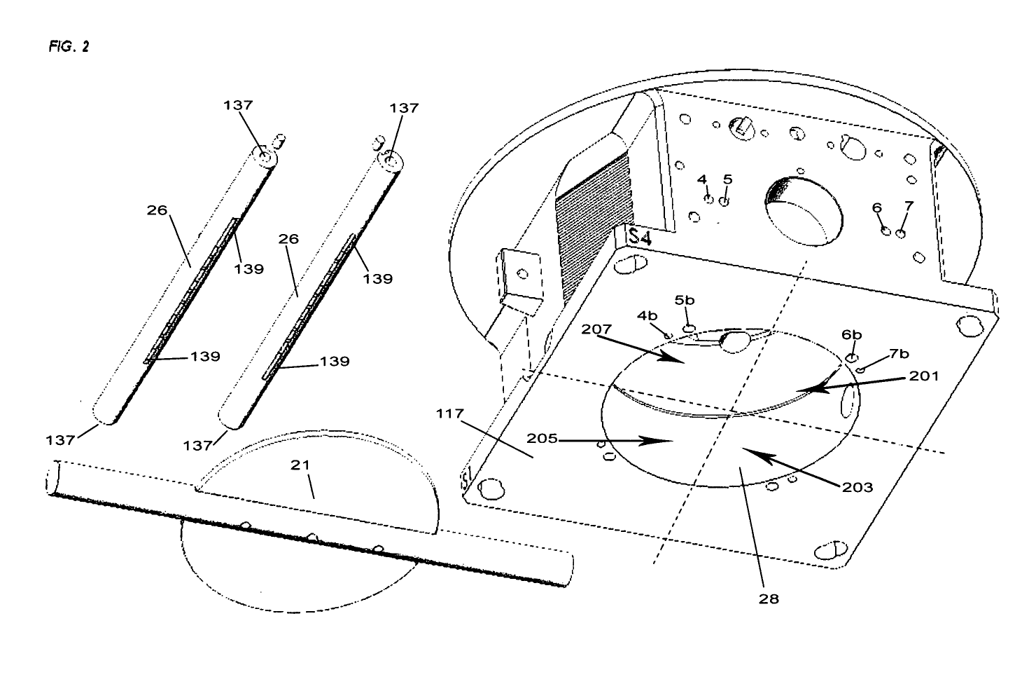

The fuel bowl assembly 113 and described in U.S. Pat. No. 4,034,026 stores the fuel prior to delivery to fuel metering body 115 (metering block) assembly. The fuel metering body 115 as described in U.S. Pat. No. 5,591,383 includes a series of hydraulic and gaseous communication passages which control the fuel delivery to the carburetor 100 as a result of the throttle position and engine operating vacuum of the vehicle which may contain the carburetor 100. The main body assembly 24 may include among other components, the venturi and butterfly valves (not shown) which are responsive to the throttle position and engine operating vacuum. The air to fuel mixture as a result of the throttle position and engine operating vacuum exit out the bottom of the main body 24 through a bottom surface aperture 28 which may be defined by the bottom surface 117 which may be connected to the front surface 105, the back surface 107 and the opposing side surfaces 109 (FIG. 2). This is a main body communication passage through which the air/fuel mixture is delivered to the internal combustion engine (not shown). Of course, within each of these respective sub assemblies are individual components, which collectively contribute to the fuel delivery to the internal combustion engine. These sub assembly components are discussed in more detail below and in the U.S. patent information. Likewise, other external linkages and components are associated with these sub assemblies.

Briefly explaining these sub assemblies 113, 115, the fuel bowl assembly 113 is the portion of the carburetor 100 where fuel is delivered from fuel tank (not shown) and is stored prior to delivery to metering block assembly 115. The fuel bowl assembly 113 includes a tub body or storage area for storing fuel from the fuel tank. The fuel bowl assembly 113 may be fastened to the main body 24 and may be affixed to the main body 24 by appropriate fasteners and gaskets for connection to fastener threaded mounting holes or other appropriate fastening devices. The fuel bowl 113 may be connected by “sandwiching” the fuel metering body 115 (metering block) as it is affixed to the main body 24 by the fasteners.

A pump diaphragm cover assembly 119 and pumping arm located on the fuel bowl assembly 113 as illustrated in FIG. 3 is operated by an external lever 131 which cooperates with a pump cam 133 which rotates the throttle shaft 20 which cooperates with the main body accelerator passage inlet 17 formed in the front surface 105 and the accelerator passage outlet 18 formed in the front surface 105. In other words, upon quick acceleration or engine revving, rotation of the throttle shaft 20 activates the pump diaphragm cover assembly 119 to provide a surge of raw fuel to the carburetor 100 so that the engine does not suffer due to an inadequate fuel supply.

The fuel metering body assembly 115 (metering block) is positioned between the main body assembly 24 and the fuel bowl assembly 113.

The fuel metering body assembly 115 (metering block) includes a plate-like structure having several fluid circuits formed therein. Among other things, the fuel metering body assembly 115 conducts fuel, assists in the regulation of the aspiration of the fuel, and assists in control of the distribution of the fuel in response to the pressure gradients created in the main body assembly 24, first and second booster fluid passages 1, 2 as shown in FIG. 1 and FIG. 2.

Engines have different fuel requirements during different phases of operation, e.g., start-up, idle, acceleration, and normal cruising operation. But on an even more fundamental level, individual cylinders of an engine have different fuel demands. Fuel must be distributed to different locations in the main body passages in different air/fuel ratios. For this reason, the invention of the preferred embodiments provides multiple fuel channels, also referred to as circuits, in the Main body assembly 24. Furthermore, individual cylinders of an engine typically have slightly different operating conditions. For instance, in a typical “V” shaped engine, the cylinders are required to draw from the single carburetor to the left and to the right, both longitudinally and latitudinally with respect to the other cylinder. In other words, one cylinder is positioned ahead of the other and to the side of another. As incoming air flows past a cylinder often another cylinder cuts off this flow of air and or fuel and redirects it towards itself. This air or fuel (depending on the blend percentage that is traveling in that manifold section at that point) is stolen or redirected by one cylinder intended for another. Creating either a leaner or richer condition for either cylinder than is optimal. Consequently, this typically leads to different air to fuel ratio demands in different quadrants of the single barrel to correct these conditions. This same preferred embodiment can be used in a dual format on a multi cylinder engine for even more control over the engines needs.

To address these different conditions and demands, the carburetor of the present invention provides for separate sections or quadrants which are individually tunable. Each section or quadrant may include a dedicated circuit which may be tuned individually. The number of sections or quadrants can be varied in accordance with the teachings of the present invention there could be two sections or quadrants, three sections or quadrants four sections or quadrants or any other number of sections or quadrants such provides each quadrant of the single barrel of the carburetor with several dedicated fuel circuits. The present invention will be explained with respect to four sections or quadrants; however, other numbers are within the scope of the present invention. Each of these circuits is individually “tunable”. In other words, the fuel delivery to the engine can be independently adjusted to affect and correct to account for different operating conditions. Current single barrel carburetor designs do not offer this option. Consequently, the single barrel carburetor of the preferred embodiments allows the fuel delivery rate to be optimized for each of quadrant of the single barrel to assist in correcting these less than optimal operating conditions an engine encounters.

Now, with particular reference to quadrant tuning the single barrel with the fuel metering assemblies and boosters 115 and boosters 26. These are defined by their implementation into the main body 24. The fuel metering body assembly is 115 and the boosters 26 are designed and implemented to serve respective quadrant of the single barrel under a particular operating condition, channels (? Where are the channels in the drawings) are defined by the main body 24, the boosters 26, and the fuel metering body assemblies (metering blocks). Each of these channels serves a respective quadrant of the single barrel under a particular operating condition. Each section or quadrant of the single barrel in the main body is served by three fluid circuits, namely, an “idle circuit”, a “transfer circuit” and a “main circuit” (described below). The separate circuits permit tuning and calibration of each quadrant of the carburetor independently in response to the specific needs of that quadrant of the engine. The “circuits” are a combination of channels, air bleeds, and passages for properly mixing and directing the air and fuel.

While the circuit may be described with respect to the front surface 105, an opposing circuit is formed with respect to the back surface 107 which substantially mirrors the circuits of the front surface 105.

The “idle circuit” first passageway extend from the first inlet port 4 formed in the front surface 105 and extends to the first outlet port 4b formed in the upper bottom surface 117 and a second passageway which extends from the second inlet port 7 formed in the front surface 105 to the second outlet port 7b formed in the upper bottom surface 117 to form a portion of the “idle circuit” that communicates with the metering block 115 and this fuel/air mixture is subsequently directed through the first passageway which extends from the first inlet port 4 to the first outlet port 4b and the second passageway which extends from the second inlet port 7 to the second outlet port 7b through the main body (these same passages are also formed on the opposite side of the main body) as it is symmetrical/mirrored in design. The “idle circuit” is the circuit through which the bulk of the low rpm (revolutions per minute) of engine speed fuel is supplied during idling conditions of the engine.

Fuel is drawn through idle passages in the main body by the vacuum created at the first and second outlet port 4b, 7b (and symmetrically on the opposite side of the main body). One end of the “idle circuit” has a discharge or outlet port (4b, 7b) which opens downstream of the main body throttle plate 21. During low engine rpm operating conditions, the main body throttle plate 21 is substantially closed. Consequently, a relatively large vacuum is generated on the downstream side of the throttle plate 21. Discharge port (4b-7b) to the idle circuit is influenced by this vacuum. Specifically, as a result of the vacuum, fuel is drawn from the fuel bowl into the fuel metering body (metering block) into the first and second inlet ports 4 and 7, whereupon the fuel enters the fluid passages connecting the first and second inlet ports 4, to 4b to the first and second outlet ports 7 to 7b and then downstream to exit below the main body throttle plate 21 and ultimately into the engine. This fuel is the main fuel supply to power the engine during low rpm operating conditions, e.g., during idling.

A first air bleed passage may be defined by a first air bleed inlet port 9 and the first air bleed outlet port 10; a second air bleed passage may be defined by a second air bleed inlet port 11 and the second air bleed outlet port 12; a third air bleed passage may be defined by a third air bleed inlet port 13 and a third air bleed outlet port 14; and a fourth air bleed passage may be defined by a fourth air bleed inlet port 15 and a fourth air bleed outlet port 16. The first, second, third and fourth air bleed passages are formed in the main body assembly 24 and are mirrored on the opposing side of the main body 24. These air bleed passages may be connected with channels that ultimately connect to the metering block 115 to assist in controlling and aspirating the fuel. The air bleed passages formed in the main body assembly 24 (these same passages also formed on the opposite side of the main body, as it is symmetrical in design) permit selective adjustment of the idle operating conditions by virtue of interchangeable idle air bleed passages corresponding to air bleed inlet ports 9 and 15 associated with the inlet side of main body assembly 24.

The “Idle circuit” air bleed passages which correspond to the air bleed inlet ports 9 and 15 denote their mounting location (also symmetrically located on the opposite side of the main body). The distal end of the respective air bleed passages for the “idle circuit”, which is also formed in the main body assembly 24 additionally corresponds to the air bleed outlet ports 10 and 16 (also symmetrically located on the opposite side of the main body). These air bleed passages transport air to assist in controlling the aspiration of fuel in the metering block 115 as the block 115 simultaneously communicates with engine vacuum to the first inlet port 4 and the second inlet port 7, this simultaneous communication results in a transfer of fuel to the idle first and second passageways defined by the first inlet port 4 and the second inlet port 7 passages, and the first transfer passageway which may be defined by the third inlet port 5 and the third outlet port 5b and the second transfer passageway which may be defined by the fourth inlet port 6 and the fourth outlet port 6 b which may be mirrored on the opposing side of the carburetor 100.

The Idle air bleed passageways may be interchangeable for fine-tuning the amount of the air bled off during “idle and transfer circuit” operation.

When increased air flow or power is demanded, the throttle shaft is rotated in a more open position, which further opens throttle plate 21. This further opening of throttle plate 21 initiates fuel delivery through the “transfer circuit.” The “transfer circuit” serves as a transition circuit between idling and booster operation. The “transfer circuit” thus supplies additional and more immediate fuel to smooth the transition from fully closed to more fully open as the engine rpms are increased. The “transfer circuit” may be a vertical slot cut in the third and fourth outlet port 5b,6b of the single barrel, inline and exposing the first transfer passageway defined by third inlet port 5 and third inlet port 5b and the second transfer passageway defined by the fourth inlet port 6 and the fourth outlet port 6b (also mirrored on the opposite side of the main body) to discharge port vacuum when the throttle blade is lightly and even fully opened. This fuel operates as an intermediate fuel delivery circuit as throttle plate 21 is opened. In other words, beyond a certain throttle opening, the idle circuit does not contribute enough fuel to the engine for stable operation. However, the negative pressure developed in the single barrel (the main passageway through main body assembly 28) is not sufficient to activate the boosters 22,23. Consequently, the transfer circuit activates and short circuits the mixture screw controlled idle circuit and delivers an increased amount of fuel from this newly exposed circuit when the blade is lightly or fully opened. This circuit continues operating until and even after the negative pressure in the boosters 22, 23 is sufficient to initiate fuel delivery.

Now, turning to the “main circuit”, each of the two fuel metering blocks 115 respectively serves each half of the two boosters, 22 and 23. Each booster 22, 23 is divided in to two sections. Each end of the booster tube 22 and 23 may include a axial Center aperture and 137 which may extend to a point so that the center aperture 137 and the opposing center aperture 137 are not connected, and the center aperture maybe formed by drilling lengthwise down its center, it is drilled down its center at a distance that is slightly less than half of its entire length, this to form a primary and secondary divider in the booster to allow fuel to travel down the center aperture 137 and may be expelled by a radial aperture 139 which may extend from the center aperture 137 to the surface of the booster 22, 23 so that each of the quadrants of the single barrel may be individually supplied with fuel from the booster 22, 23. This division of the booster, the idle, the transfer circuits and subsequent employment of a modular metering block and fuel bowl configuration allows single barrel quadrant tuning capability. Each fuel metering block is equipped with main booster jetting circuits or apertures 137 for each half of each booster it supplies. This layout contributes to the effectiveness of quadrant tuning of the single barrels air to fuel ratio. Each booster is also equipped with multiple exit apertures that assists to further atomize and properly distribute the aspirated fuel as it is discharged from the booster into the single barrel of the main body. FIG. 2 illustrates a first quadrant 201, a second quadrant 203, a third quadrant 205, a fourth quadrant 207 which may be individually tunable within a single barrel.

The “main circuit” also includes a first and second air bleeds passageways defined by air bleed outlet 11, 13, (also symmetrically located on the opposite side of the main body). The distal end of the first and second air bleed passageways for the “main circuit”, which is also formed in the main body assembly 24, open into air bleed outlet 12, 14 (also symmetrically located on the opposite side of the main body). These channels/first and second air bleed passageway distribute controlled air supplies to assist in controlling the aspiration of fuel in the metering block 115 as the metering block 115 communicates and prior to the transfer of fuel to the main body passages. The high speed air bleed passageways are interchangeable for fine-tuning the amount of the air bled off during “main circuit” operation.

Finally, the top surface 111 of the main body assembly 24 also includes a bowl vent passage (also symmetrically located on the opposite side of the main body) which may be defined by the bowl vent inlet and out let port 25, 25b and an accelerator pump channel which may be defined by an inlet and outlet accelerator pump ports 17, 18, also symmetrically located on the opposite side of the main body.

As in FIG. 1, the main body 24 includes a single barrel opening, two boosters 22, 23. These boosters 22, 23 provide constrictions in the air flow passage which creates a pressure drop. Consequently, as the air flows across the boosters at the narrowest area of the single barrel, the air is accelerated, which facilitates the atomization of fuel droplets into the air prior to delivery to the engine's cylinders. Main body 24 has one air induction passage. This air induction passage extends through the main body assembly 24.

Each booster FIG. 1 Items 22 and 23 are slid into the main body and sealed by a body mounted O-ring, each booster is located by a locating pin 27. The boosters and associated fluid feed paths are substantially identical, so just like our earlier systems, a description of one will serve to describe both. The booster has a fuel feed passage and atomization apertures 26. These fuel feed passage and atomization apertures 26 supply fuel to the single barrel of the main body 24 during off idle demand conditions. Consequently, by virtue of having outlet ports along the length of the booster, an even distribution of fuel is provided. Because the booster is divided in half, quadrant distribution of fuel can controllable by varying the hole size along the length of the booster as well, to optimize engine requirements. This design in turn provides a more controlled delivery of fuel into the air supply at part throttle operation as well as during wide open throttle operation.

During normal cruise conditions, i.e., when throttle plate 21 is open, air flowing across the boosters 26 creates a pressure drop at the atomization apertures 26, this communication in the form of a pressure drop is transferred to the booster channel. This same communication is then transferred to the metering block channels. This pressure drop creates a suction effect which tends to draw fuel from the channels of the metering block 115 and the fuel bowl 113. This fuel is delivered through the atomization apertures 26 on the booster 26, where the fuel is introduced and aspirated into the engines air supply flowing out through induction passage 28.

As mentioned previously, a pair of boosters 22, 23 and interchangeable high speed air bleeds 11, 13 are also provided (also symmetrically located on the opposite side of the main body). High speed air bleeds 11, 13 may be interchanged to fine-tune the performance of the boosters. The high speed air bleeds 11, 13 are in fluid communication with the metering block through the main body at outlet ports 12, 14. The high speed air bleed passage “short-circuits” the suction created by boosters to reduce the amount of fuel which would be delivered to the single barrel passage if the air bleeds were not provided.

An idle air bleed inlet ports 9, 15 are also provided. The idle air bleed inlet ports 9, 15 is also interchangeable to fine-tune the performance of the idle circuit. Idle air bleed is in fluid communication with the metering block through the outlet ports 10 and 16 on the main body 24. The idle air bleed passageway defined by the inlet ports nine, 15 and the outlet ports 10, 16 also “short circuits” the suction created by idle discharge port 4b. 7b (also symmetrically located on the opposite side of the main body) to reduce the amount of fuel which would be delivered to idle discharge port 4b, 7b (also symmetrically located on the opposite side of the main body).

A pair of accelerator pump discharge nozzles 118 (pump squirters) may be positioned on the top surface 111 of the main body 24 (also symmetrically mounted on the opposite passage location on the opposite side of the main body). This accelerator pump discharge nozzle 118 (pump squirter) is in fluid communication with the accelerator passageway which may be defined by the inlet and outlet port 17, 18. Upon demanded acceleration, the throttle shaft 20 is rotated by the operator, this rotates an accelerator pump cam 133 which is affixed to the throttle shaft 131, which in turn actuates a pump arm assembly 119 which in turn actuates another lever 120 which is located on the accelerator pump housing assembly 121. This action pumps fluid into the accelerator passage. The fluid in the accelerator passage defined by the inlet port 17 and the outlet port 18 is delivered to the accelerator pump discharge nozzle 118 (pump squirter) as raw fuel. Although the raw fuel is not aspirated, the quick rotation of the throttle associated with a request for acceleration often does not provide enough time for the fuel to be properly aspirated through either of the three fluid circuits. Consequently, the raw fuel allows the engine to accelerate substantially instantaneously in response to the shaft rotation, without the engine bucking or stalling due to an inadequate fuel supply. Advantageously, a hold down screw 114 is associated with the accelerator pump discharge nozzle 118 is interchangeable to permit selective adjustment of the fuel delivered upon demanded engine acceleration, again permitting the fine-tuning of the fuel delivery for optimum performance of the engine.

Without being limited to any theory of operation, it is believed that the provision of a communication path to correct air to fuel ratios in each quadrant of the single barrel passage provides unique advantages, not the least of which is the increased horsepower which has been observed on a dynamometer.

For instance, the operation of the accelerator pump system is a very standard and well known format incorporating a pump cam and levers. Other known use of items that are also only briefly described are: The throttle valve shaft Item 20 extends across the induction passage. The throttle plate Item 21 is operatively connected to the throttle valve shaft to allow it to operate and is located within the single barrel induction passage. The main body has a ledge upon it to mount a screw to adjust the idle speed as it connects with the throttle valve shaft 20. The main body has a ledge upon it to allow the throttle valve shaft 20 to have a positive stop position at wide open throttle

As will now be appreciated, the single barrel quadrant tunable main body and ultimately this assembly of modular components referred to as carburetor 100 may or may not be an integral part of an engine. In operation: Fuel enters the fuel bowl assembly from the fuel tank. The fuel fills the bowl to a predetermined point based on the adjustable float assembly. The engine is primed and started and instantly creates vacuum, outside air is taken into the engine. The air passes into the main body passages and mixes air with fuel to allow the engine to run. The throttle shaft is rotated and air is drawn in and is constricted by the boosters 22 and 23 creating a pressure drop compared to atmospheric pressure and the pressure within the fluid channels of the fuel metering body assembly allow fuel to flow through the boosters. This fuel is then delivered to the engine through the metering block and boosters and the aspirated fuel is mixed with the incoming air through the single barrel after the various air bleeds to emulsify and aspirate the fuel have done their work. The actual path of the fuel through the various metering systems and main body assembly is determined by the phase of the throttle position and engine vacuum created. The mixture is then delivered to the engine's combustion chambers and power is created inside the engine.

While the examples given in the specification and drawings relate to a multi cylinder application, it is noted that the invention can be adapted to single cylinder engines as well as its intended multi cylinder application.

This invention has been described in connection with preferred embodiments. These embodiments are intended to be illustrative only. It will be readily appreciated by those skilled in the art that modifications may be made to these preferred embodiments without departing from the scope of the invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

What is claimed is:

1) A carburetor main body assembly for an engine, comprising:
a main body having a single body passage having a single intake port connected to a single discharge port, the discharge port for connecting to a plenum of the engine;
a single throttle plate disposed within the single body passage, the throttle plate operable to regulate airflow through the body passage;
wherein the main body includes a first section to supply fuel to the engine and a second section to supply fuel to the engine and wherein the first section is independent in operation from the second section.

2) A carburetor main body assembly for an engine as in claim 1, wherein the first section is a first quadrant.

3) A carburetor main body assembly for an engine as in claim 1, wherein the second section is a second quadrant.

4) A carburetor main body assembly for an engine as in claim 1, wherein the carburetor main body includes a third section which is independent in operation from the first section and the second section.

5) A carburetor main body assembly for an engine as in claim 4, wherein the carburetor main body includes a fourth section which is independent in operation from the first section, the second section, and the third section.

6. A carburetor main body assembly for an engine as in claim 4, wherein the third section is a third quadrant.

7) A carburetor main body assembly for an engine as in claim 5, wherein the fourth section is a fourth quadrant.

8) A carburetor main body assembly for an engine as in claim 1, wherein the first section includes a first idle circuit.

9) A carburetor main body assembly for an engine as in claim 8, wherein the second section includes a second idle circuit.

10) A carburetor main body assembly for an engine as in claim 9, wherein the first idle circuit operates independently of the second idle circuit.

11) A carburetor main body assembly for an engine as in claim 1, wherein the first section includes a first transfer circuit.

12) A carburetor main body assembly for an engine as in claim 11, wherein the second section includes a second transfer circuit.

13) A carburetor main body assembly for an engine as in claim 12, wherein the first transfer circuit operates independently of the second transfer circuit.

14) A carburetor main body assembly for an engine as in claim 1, wherein the first section includes a first main circuit.

15) A carburetor main body assembly for an engine as in claim 14, wherein the second section includes a second main circuit.

16) A carburetor main body assembly for an engine as in claim 15, wherein the first main circuit operates independently of the second main circuit.

17) A carburetor main body assembly for an engine as in claim 1, wherein the carburetor assembly includes a first metering body which corresponds to the first section.

18) A carburetor main body assembly for an engine as in claim 17, wherein the carburetor assembly includes a second metering body which corresponds to the second section.

19) A carburetor main body assembly for an engine as in claim 18, wherein the first metering body operates independently of the second metering body.
